(19) United States
(12) Patent Application Publication
(10) Pub. No.: US 2016/0302468 A1
(43) Pub. Date: Oct. 20, 2016

(54) SYSTEM AND METHOD FOR DOSING A POPPING CHAMBER

(71) Applicant: INTERCONTINENTAL GREAT BRANDS LLC, East Hanover, NJ (US)

(72) Inventor: Chris E. ROBINSON, East Hanover, NJ (US)

(73) Assignee: Intercontinental Great Brands LLC, East Hanover, NJ (US)

(21) Appl. No.: 15/035,250

(22) PCT Filed: Nov. 5, 2014
(86) PCT No.: PCT/US14/64102

§ 371 Date: May 9, 2016

Related U.S. Application Data
(60) Provisional application No. 61/902,040, filed on Nov. 8, 2013.

(51) Int. Cl. A23L 1/18

(52) U.S. Cl. CPC A23P 1/142; A23L 1/0085; A23V 2002/00

(57) ABSTRACT

A method of dosing a popping chamber with a predetermined quantity of bulk starch material comprises placing bulk material into a feed hopper, positioning a dosing plate and a shuttle plate into a charging position relative to the seal plate, and positioning the dosing plate and the shuttle plate into a dosing position relative to the popping chamber and to the seal plate. The dosing position is characterized by alignment of the dosing apertures and the shuttle apertures and misalignment of the seal plate apertures and the dosing apertures such that the bulk material retained in the dosing apertures in the charging position flows through the dosing apertures and the shuttle apertures into the popping chamber in the dosing position and bulk material is not flowable through the seal plate apertures into the dosing apertures in the dosing position.

### CROSS-REFERENCE TO RELATED APPLICATIONS

This application claims the benefit of U.S. Provisional Patent Application No. 61/902,040 filed Nov. 8, 2013 and entitled “System And Method For Dosing A Popping Chamber”, which is incorporated by reference herein in its entirety.

### BACKGROUND OF THE INVENTION

Reducing waste of raw material during production of pressure baked snacks is of great interest to producers of large quantities of such products. Moreover, controlling the flow of raw material is not merely a matter of controlling waste; it is also the means by which one controls product consistency and influences the total cost of finished goods. There is therefore a need to promote the efficient and predictable flow of raw material from the bulk handling unit operations (e.g., the hopper) to the baking chamber (e.g., the popping chamber). Starch puffing equipment is known. In some prior systems, there is an engineered gap between the bottom of the feed hopper and the top of the dosing plate. This gap may be set at no more than the height of the individual granule of bulk material in the feed hopper. Generally at least some nominal gap exists to prevent metal-to-metal contact between the bottom of the feed hopper and the top of the dosing plate. In one case, a gap of about ½ the thickness of a granule (e.g., a pellet) is pre-set prior to production.

Since some bulk materials (such as pellets) are mass produced and subject to size variations, smaller pellets can and do move through the gap in some cases. Moreover, although the pellets can nest within the dosing aperture there may be the possibility of a full pellet that is only partially nested (e.g., at the top of the dosing stack) trying to either go through the gap (e.g., where the gap is not wide enough to accommodate the pellet) or being held back by the front edge of the feed hopper. In some cases the leading edge of the incompletely nested pellets gets forced under the leading edge of the hopper mechanism—these pellets are then compressed into the charged cavity as they pass beneath the hoppers leading edge. Once free of the hoppers leading edge, the compression is instantly minimized. The pellets that have been compressed are now free to “pop” out of the cavity.

These “free flying” pellets can be propelled into undesirable locations. Thus there may be loose pellets lying on various parts of the popping machine. In some cases, the loose pellets can fall into one of the bake chambers thereby changing the charge weight in the chamber. These heavily charged cavities may cause an uncommon pressure gradient across the upper and lower dies as they close (e.g., via hydraulic force) to cook the pellets. This in turn may result in a finished product that is heavy in weight—out of the desired shape range—excess flashing, undesirable texturing and or all the aforementioned attributes. The uncommon pressure gradient may, therefore, affect the attributes of the other products made during that particular bake cycle (in varying degrees).

### BRIEF SUMMARY OF THE INVENTION

In one embodiment, there is a method for dosing a popping chamber with a predetermined quantity of bulk starch material. The method includes placing bulk material into a feed hopper, the feed hopper having sidewalls and a seal plate fixed relative to the sidewalls, the seal plate having a plurality of seal plate apertures passing therethrough, the seal plate apertures being configured to guide a flow of bulk material from the feed hopper through the seal plate; positioning a dosing plate and a shuttle plate into a charging position relative to the seal plate, the dosing plate having a plurality of dosing apertures therethrough and the shuttle plate having a plurality of shuttle apertures therethrough, the charging position being characterized by the plurality of dosing apertures being in alignment with the plurality of seal plate apertures and by the plurality of shuttle apertures being misaligned with the plurality of dosing apertures such that bulk material is flowable through the seal plate apertures into the dosing apertures and that bulk material that is flowable into the dosing apertures is retained in the dosing apertures; and positioning the dosing plate and the shuttle plate into a dosing position relative to the popping chamber and to the seal plate, the dosing position being characterized by alignment of the dosing apertures and the shuttle apertures and misalignment of the seal plate apertures and the dosing apertures such that the bulk material retained in the dosing apertures in the charging position flows through the dosing apertures and the shuttle apertures into the popping chamber in the dosing position, and bulk material for the feed hopper is not flowable through the seal plate apertures into the dosing apertures in the dosing position. In some embodiments of the method, the seal plate has a lower surface that is slidable while being engaged with an upper surface of the dosing plate. In some embodiments of the method, the seal plate has a lower seal plate surface and the dosing plate has an upper dosing surface, there being a preselected gap between the lower seal plate surface and the dosing surface when the dosing plate and seal plate are in the charging position. In some embodiments of the method, the bulk material includes individual starchy components having an approximately uniform grain size from component to component and the preselected gap is less than or equal to one-half the grain size. The seal plate apertures in some embodiments may also be defined by an upper chamfered wall and a lower cylindrical wall. The method may further include repeating the steps such that each time the dosing plate and the shuttle plate are moved into the dosing position, the amount of bulk material retained in the dosing plate is substantially the same.

There is also disclosed herein a system for dosing a popping chamber with a predetermined quantity of bulk starch material. In some embodiments, the system includes a plurality of starch material puffing chambers configured to apply pressure and heat to the bulk starch material and to allow the bulk starch material to puff upon a removal of pressure and heat from the chamber; a feed hopper configured to retain the starch material prior to placement into the puffing chamber, the feed hopper comprising a seal plate having a plurality of seal plate apertures passing therethrough, the seal plate apertures configured to guide a preselected quantity of the bulk starch material from the feed hopper through the seal plate; a dosing plate having a plurality of dosing apertures alignable with the seal plate apertures, the dosing plate slidable relative to the seal plate such that in a charging position, the dosing apertures are aligned with the seal plate apertures and in a feeding position, the dosing apertures are misaligned with the seal plate apertures; and a shuttle plate having a plurality of shuttle apertures alignable with the dosing apertures, the shuttle plate being slidable relative to the dosing plate such that in the charging position, the shuttle apertures are misaligned with the dosing apertures and in the dosing position, the shuttle apertures are aligned with the dosing apertures.

In some embodiments of the system, the seal plate includes a notch for receiving sidewalls of the feed hopper such that the sidewalls are sealed to the seal plate. In further embodiments of the system, the seal plate and the dosing plate are in parallel alignment with each other, the system further comprising a gap of a selectable distance between the seal plate and the dosing plate. In still further embodiments, the plurality of puffing chambers are arranged in an array, each puffing chamber having a substantially equal diameter and the seal plate, the dosing plate and the shuttle plate each have a plurality of apertures that are arranged in an array that substantially matches the array of the plurality of puffing chambers, and each of the apertures in the seal plate, the dosing plate and shuttle plate are substantially equal to one another in diameter and are smaller than the diameter of the puffing chambers.

### BRIEF DESCRIPTION OF THE SEVERAL VIEWS OF THE DRAWINGS

The foregoing summary, as well as the following detailed description of embodiments of the system and method for dosing a popping chamber, will be better understood when read in conjunction with the appended drawings of an exemplary embodiment. It should be understood, however, that the invention is not limited to the precise arrangements and instrumentalities shown.

In the drawings:

FIG. 1 is a cross sectional side view of a popping chamber system in accordance with an exemplary embodiment of the present invention shown in a charging position; and

FIG. 2 is a cross sectional side view of the popping chamber system of FIG. 1 shown in the dosing position.

### DETAILED DESCRIPTION OF THE INVENTION

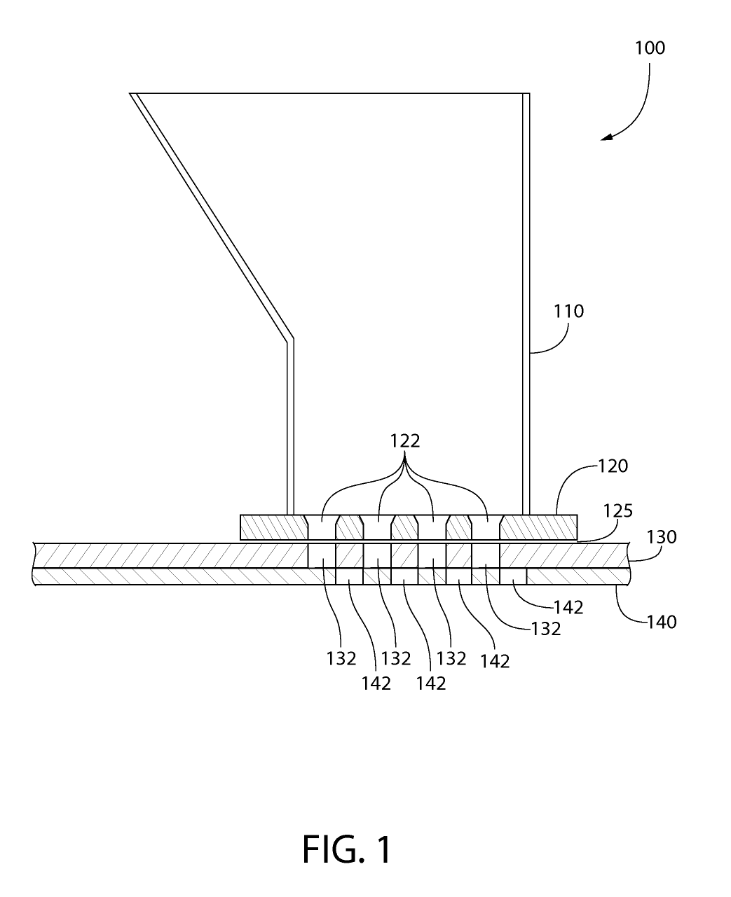

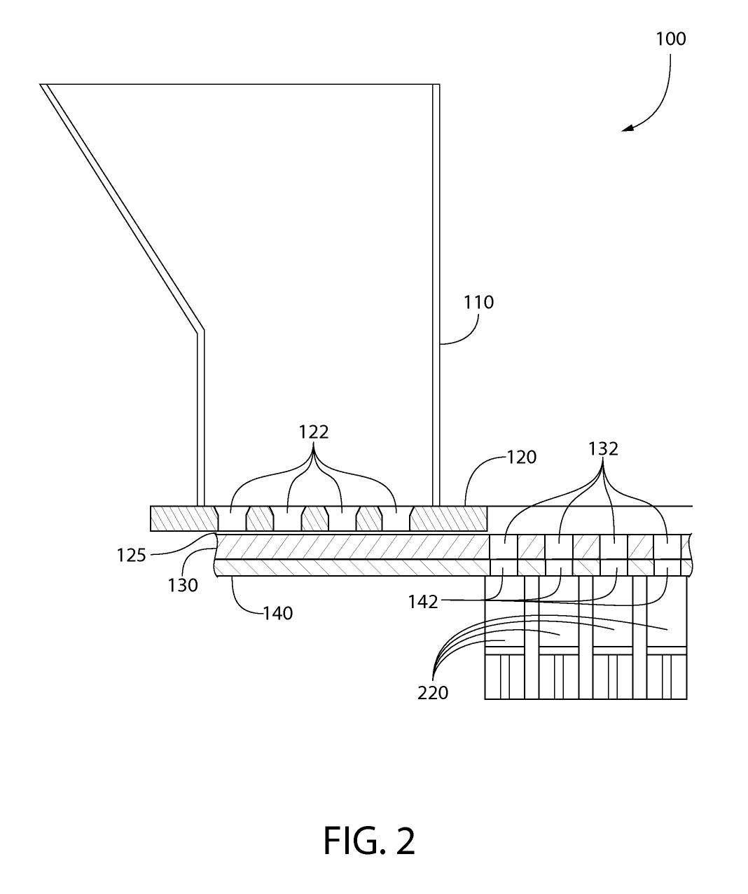

Bulk starch material puffing systems are described in U.S. Pat. No. 8,227,005, the entirety of which is incorporated herein by reference. FIGS. 1 and 2 illustrate one exemplary embodiment of the bulk starch material puffing system and method of the present invention. FIG. 1 illustrates one embodiment of puffing system 100 having a feed hopper 110, a seal plate 120, a dosing plate 130 and a shuttle plate 140.

In one embodiment, seal plate 120 is integral with and/or forms a part of hopper 110. In another embodiment, seal plate 120 is detachable from hopper 110. It is preferred that, during operation, seal plate 120 is fixed relative to feed hopper 110. For example, seal plate 120 can include notches into which the sidewalls of feel hopper 110 seat in order to form a seal between feed hopper 110 and seal plate 120. In a preferred embodiment, seal plate 120 includes a plurality of seal plate apertures 122 that extend through seal plate 120. Seal plate apertures 122 may be cylindrical apertures being radically disposed about a longitudinal axis that is normal to the plane of seal plate 120. Seal plate apertures 122 may be defined by a lower cylindrical wall and an upper beveled or chamfered wall as illustrated in FIG. 1. The seal plate apertures 122 in seal plate 120 may be arranged in an array. Preferably the array substantially matches an array of puffing chambers. For example, a 4×8 array would include 32 seal plate apertures 122 that correspond with 32 puffing chambers.

In one embodiment, seal plate 120 is constructed from food grade polymer. Ultra high molecular weight polyethylene (UHMWPE) may be suitable. In one embodiment, the material is high heat resistant and has a low coefficient of friction.

System 100 may further include dosing plate 130. In one embodiment, dosing plate 130 is configured to move in a sliding fashion relative to seal plate 120. In one embodiment, dosing plate 130 slides along and beneath seal plate 120 and is configured to rub against seal plate 120. In one embodiment, there is a gap 125 between seal plate 120 and dosing plate 130. Gap 125 may be adjustable to accommodate various types of bulk material to be processed by system 100. In one embodiment, for example, system 100 is configured to puff granular bulk material such as grain or manufacture pellets. Gap 125 may be sized based upon the size of the granular material. For example, a grain size may be specified as the maximum grain size that would pass through a particular sieve size. The gap 125 may then be set relative to that maximum grain size. In one embodiment, the gap is set to one-half the maximum grain size. In another embodiment, the gap is set to ¼ of the maximum grain size. In one embodiment, the gap is set to zero gap.

Dosing plate 130 preferably also contains a plurality of dosing apertures 132 that are arranged in an array of the same size as the seal plate array. Preferably, dosing apertures 132 are configured to align into register with seal plate apertures 122 such that in operation, bulk material can flow through seal plate apertures 122 into dosing apertures 132. In operation, material is preferably loaded into hopper 110 such that it flows into seal plate apertures 122 and, when in alignment, dosing apertures 132 when dosing plate 130 is in the charging position illustrated in FIG. 1. When system 100 is in a dosing position, illustrated in FIG. 2, dosing plate 130 can be configured to block off seal plate apertures 122 such that no material can flow through sealing plate apertures 122.

System 100 may further include shuttle plate 140. In one embodiment, shuttle plate 140 is configured to move in a sliding fashion relative to (and below) dosing plate 130. Shuttle plate 140 may further be configured with a plurality of shuttle apertures 142. The plurality of shuttle aperture 142 may be further arranged in array that would permit shuttle apertures 142 to be aligned in register with dosing apertures 132 such as in the feeding position illustrated in FIG. 2.

In a preferred embodiment, when system 100 is in a charging position (FIG. 1), shuttle apertures 142 are misaligned with dosing apertures 132 thereby creating a pocket in which bulk material can be retained in dosing apertures 132. By moving from the charging position (FIG. 1) to the feeding or dosing position (FIG. 2), a fixed quantity of pellets can be loaded into puffing chambers 220 thereby facilitating a uniform product.

In operation, the preferred system promotes a desired effect of having a predetermined number of pellets entering the puffing chamber 220 time after time. The predetermined dose may be a result of the ‘volume’ of the cavity formed by the dosing apertures 132. Where the cavity volume can be calculated as radius²×PI×height of the cavity. Thus, if a high charging count is desired, one might select a larger diameter dosing plate aperture 132. Thus dosing plate 130 may be readily replaceable in system 100.

In operation, once dosing plate apertures 132 are charged (FIG. 1), dosing plate 130 and shuttle plate 140 may move in unison, with dosing apertures 132 and shuttle apertures 142 unaligned, toward and over the puffing chambers 220. Thus all the pellets that are not in dosing apertures 132 must be contained within hopper 110 thereby eliminating the possibly that over charged puffing chambers will create products of random weight. Once dosing apertures 132 are aligned with puffing chambers 220, shuttle plate 140 is moved relative to dosing plate 130 such that shuttle apertures 142 are aligned with dosing apertures 132 to release the pellets contained in dosing apertures 132 into the respective puffing chambers 220 (FIG. 2). In another embodiment, once shuttle apertures 142 are aligned with puffing chambers 220, dosing plate 130 is moved relative to shuttle plate 140 such that dosing apertures 132 are aligned with shuttle apertures 142 to release the pellets contained in dosing apertures 132 into the respective puffing chambers 220. Once the pellets are released from dosing apertures 132, shuttle plate 140 and dosing plate 130 may be moved relative to one another such that dosing apertures 132 and shuttle apertures 142 are unaligned and then dosing plate 130 and shuttle plate 140 may be moved in unison until the dosing apertures 132 are aligned with the seal plate apertures in the charging position (FIG. 1).

By eliminating pinch points between hopper sidewalls and the dosing plates, individual grains or pellets are less likely to create a “spring boarding” of the unnested pellets as they pass under the relatively thin metal edge of the feed hopper.

There is thus a method of dosing a popping chamber with a predetermined quantity of bulk starch material. The method includes placing bulk material into a feed hopper, the feed hopper having sidewalls and a seal plate fixed relative to the sidewalls, the seal plate having a plurality of seal plate apertures passing therethrough, the seal plate apertures being configured to guide a flow of bulk material from the feed hopper through the seal plate. The method also includes positioning a dosing plate and a shuttle plate into a charging position relative to the seal plate, the dosing plate having a plurality of dosing apertures therethrough and the shuttle plate having a plurality of shuttle apertures therethrough, the charging position being characterized by the plurality of dosing apertures being in alignment with the plurality of seal plate apertures and by the plurality of shuttle apertures being misaligned with the plurality of dosing apertures such that bulk material is flowable through the seal plate apertures into the dosing apertures and that bulk material that is flowable into the dosing apertures is retained in the dosing apertures. The method further includes, positioning the dosing plate and the shuttle plate into a dosing position relative to the popping chamber and to the seal plate, the dosing position being characterized by alignment of the dosing apertures and the shuttle apertures and misalignment of the seal plate apertures and the dosing apertures such that the bulk material retained in the dosing apertures in the charging position flows through the dosing apertures and the shuttle apertures into the popping chamber in the dosing position and bulk material is not flowable through the seal plate apertures into the dosing apertures in the dosing position.

In one embodiment, the system 100 includes one or more computers having one or more processors and memory (e.g., one or more nonvolatile storage devices). In some embodiments, memory or computer readable storage medium of memory stores programs, modules and data structures, or a subset thereof for a processor to control and run the various systems and methods disclosed herein. In one embodiment, a non-transitory computer readable storage medium having stored thereon computer-executable instructions which, when executed by a processor, perform one or more of the methods disclosed herein.

It will be appreciated by those skilled in the art that changes could be made to the exemplary embodiments shown and described above without departing from the broad inventive concepts thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

I/we claim:

1. A method of dosing a popping chamber with a predetermined quantity of bulk starch material comprising:
placing bulk material into a feed hopper, the feed hopper having sidewalls and a seal plate fixed relative to the sidewalls, the seal plate having a plurality of seal plate apertures passing therethrough, the seal plate apertures being configured to guide a flow of the bulk material from the feed hopper through the seal plate;
positioning a dosing plate and a shuttle plate into a charging position relative to the seal plate, the dosing plate having a plurality of dosing apertures therethrough and the shuttle plate having a plurality of shuttle apertures therethrough, the charging position being characterized by the plurality of dosing apertures being in alignment with the plurality of seal plate apertures and by the plurality of shuttle apertures being misaligned with the plurality of dosing apertures such that bulk material is flowable through the seal plate apertures into the dosing apertures and that bulk material that is flowable into the dosing apertures is retained in the dosing apertures; and
positioning the dosing plate and the shuttle plate into a dosing position relative to the popping chamber and to the seal plate, the dosing position being characterized by alignment of the dosing apertures and the shuttle apertures and misalignment of the seal plate apertures and the dosing apertures such that the bulk material retained in the dosing apertures in the charging position flows through the dosing apertures and the shuttle apertures into the popping chamber in the dosing position and bulk material is not flowable through the seal plate apertures into the dosing apertures in the dosing position.

2. The method of claim 1, wherein the seal plate has a lower surface that is slidably engaged with an upper surface of the dosing plate.

3. The method of claim 1, wherein the seal plate has a lower seal plate surface and the dosing plate has an upper dosing surface there being a preselected gap between the lower seal plate surface and the dosing surface when the dosing plate and seal plate in the charging position.

4. The method of claim 3, wherein the bulk material comprises individual starchy components having a approximately uniform grain size from component to component and the preselected gap is less than or equal to one-half the grain size.

5. The method of claim 1, wherein seal plate apertures are defined by an upper chamfered wall and a lower cylindrical wall.

6. The method of claim 1 further comprising:
repeating the steps of claim 1 such that each time the dosing plate and the shuttle plate are moved into the dosing position, the amount of bulk material retained in the dosing plate is substantially the same.

7. A system for dosing a popping chamber with a predetermined quantity of bulk starch material comprising:
a plurality of puffing chambers configured to apply pressure and heat to the bulk starch material within the puffing chambers and to allow the bulk starch material to puff upon a removal of pressure and heat from the puffing chambers;
a feed hopper configured to retain the starch material prior to placement into the puffing chambers, the feed hopper comprising a seal plate having a plurality of seal plate apertures passing therethrough, the seal plate apertures configured to guide a preselected quantity of the bulk starch material from the feed hopper through the seal plate;
a dosing plate having a plurality of dosing apertures alignable with the seal plate apertures, the dosing plate slidable relative to the seal plate such that in a charging position, the dosing apertures are aligned with the seal plate apertures and in a feeding position, the dosing apertures are misaligned with the seal plate apertures; and
a shuttle plate having a plurality of shuttle apertures alignable with the dosing apertures, the shuttle plate being slidable relative to the dosing plate such that in the charging position, the shuttle apertures are misaligned with the dosing apertures and in the dosing position, the shuttle apertures are aligned with the dosing apertures.

8. The system of claim 7, wherein the seal plate includes a notch for receiving sidewalls of the feed hopper such that the sidewalls are sealed to the seal plate.

9. The system of claim 7, wherein the seal plate and the dosing plate are in parallel alignment with each other, the system further comprising a gap of a selectable distance between the seal plate and the dosing plate.

10. The system of claim 7, wherein the plurality of puffing chambers are arranged in an array, each puffing chamber having a substantially equal diameter, and wherein the seal plate, the dosing plate and the shuttle plate each have a plurality of apertures that are arranged in an array that substantially matches the array of the plurality of puffing chambers, and wherein each of the apertures in the seal plate, the dosing plate and shuttle plate are substantially equal to one another in diameter and are smaller than the diameter of the puffing chambers.
